(19) United States
(12) Patent Application Publication
(10) Pub. No.: US 2007/0299713 A1
(43) Pub. Date: Dec. 27, 2007

(54) CAPTURE OF PROCESS KNOWLEDGE FOR USER ACTIVITIES

(75) Inventors: Steven W. Macbeth, Snohomish, WA (US); Roland L. Fernandez, Woodinville, WA (US); Brian R. Meyers, Issaquah, WA (US); Desney S. Tan, Kirkland, WA (US); George G. Robertson, Seattle, WA (US); Nuria M. Oliver, Seattle, WA (US); Oscar E. Murillo, Seattle, WA (US); Elin R. Pedersen, Seattle, WA (US); Jeanine E. Spence, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/426,832

(22) Filed: Jun. 27, 2006

(51) Int. Cl. G06F 15/02

(52) U.S. Cl. 705/9

(57) ABSTRACT

A system that enables generation and/or modification of an activity template is disclosed. The activity template describes overall actions and resources associated with an activity. The system can automatically convert activity logs into recipes thereby reducing effort in activity reproduction. Self-tuning via machine learning-based algorithms can be employed thereby dynamically altering the template in accordance with on-going or historical user action.

### CROSS REFERENCE TO RELATED APPLICATION(S)

This application is related to U.S. patent application Ser. No. ______ (Attorney Docket Number MS315859.01/MSFTP1290US) filed on Jun. 27, 2006, entitled “LOGGING USER ACTIONS WITHIN ACTIVITY CONTEXT”, ______ (Attorney Docket Number MS315860.01/MSFTP1291US) filed on Jun. 27, 2006, entitled “RESOURCE AVAILABILITY FOR USER ACTIVITIES ACROSS DEVICES”, ______ (Attorney Docket Number MS315862.01/MSFTP1293US) filed on Jun. 27, 2006, entitled “PROVIDING USER INFORMATION TO INTROSPECTION”, ______ (Attorney Docket Number MS315863.01/MSFTP1294US) filed on Jun. 27, 2006, entitled “MONITORING GROUP ACTIVITIES”, ______ (Attorney Docket Number MS315864.01/MSFTP1295US) filed on Jun. 27, 2006, entitled “MANAGING ACTIVITY-CENTRIC ENVIRONMENTS VIA USER PROFILES”, ______ (Attorney Docket Number MS315865.01/MSFTP1296US) filed on Jun. 27, 2006, entitled “CREATING AND MANAGING ACTIVITY-CENTRIC WORKFLOW”, ______ (Attorney Docket Number MS315866.01/MSFTP1297US) filed on Jun. 27, 2006, entitled “ACTIVITY-CENTRIC ADAPTIVE USER INTERFACE”, ______ (Attorney Docket Number MS315867.01/MSFTP1298US) filed on Jun. 27, 2006, entitled “ACTIVITY-CENTRIC DOMAIN SCOPING”, and (Attorney Docket Number MS315868.01/MSFTP1299US) filed on Jun. 27, 2006, entitled “ACTIVITY-CENTRIC GRANULAR APPLICATION FUNCTIONALITY”. The entirety of each of the above applications is incorporated herein by reference.

### BACKGROUND

Conventionally, communications between humans and machines has not been natural. Human-human communication typically involves spoken language combined with hand and facial gestures or expressions, and with the humans understanding the context of the communication. Human-machine communication is typically much more constrained, with devices like keyboards and mice for input, and symbolic or iconic images on a display for output, and with the machine understanding very little of the context. For example, although communication mechanisms (e.g., speech recognition systems) continue to develop, these systems do not automatically adapt to the activity of a user. As well, traditional systems do not consider contextual factors (e.g., user state, application state, environment conditions) to improve communications and interactivity between humans and machines.

Activity-centric concepts are generally directed to ways to make interaction with computers more natural (by providing some additional context for the communication). Traditionally, computer interaction centers around one of three pivots, 1) document-centric, 2) application-centric, and 3) device-centric. However, most conventional systems cannot operate upon more than one pivot simultaneously, and those that can do not provide much assistance managing the pivots. Hence, users are burdened with the tedious task of managing every little aspect of their tasks/activities.

A document-centric system refers to a system where a user first locates and opens a desired data file before being able to work with it. Similarly, conventional application-centric systems refer to first locating a desired application, then opening and/or creating a file or document using the desired application. Finally, a device-centric system refers to first choosing a device for a specific activity and then finding the desired application and/or document and subsequently working with the application and/or document with the chosen device.

Accordingly, since the traditional computer currently has little or no notion of activity built in to it, users are provided little direct support for translating the “real world” activity they are trying to use the computer to accomplish and the steps, resources and applications necessary on the computer to accomplish the “real world” activity. Thus, users traditionally have to assemble “activities” manually using the existing pieces (e.g., across documents, applications, and devices). As well, once users manually assemble these pieces into activities, they need to manage this list mentally, as there is little or no support for managing this on current systems.

All in all, the activity-centric concept is based upon the notion that users are leveraging a computer to complete some real world activity. Historically, a user has had to outline and prioritize the steps or actions necessary to complete a particular activity mentally before starting to work on that activity on the computer. Conventional systems do not provide for systems that enable the identification and decomposition of actions necessary to complete an activity. In other words, there is currently no integrated mechanism available that can dynamically understand what activity is taking place as well as what steps or actions are necessary to complete the activity.

Most often, the conventional computer system has used the desktop metaphor, where there was only one desktop. Moreover, these systems stored documents in a single filing cabinet. As the complexity of activities rises, and as the similarity of the activities diverges, this structure does not offer user-friendly access to necessary resources for a particular activity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that enables generation and/or modification of an activity template. The activity template describes overall actions and resources associated with an activity. For example, the innovation provides for a system that enables a newly hired information worker to comply with practices within a particular group by using the group's standard template (or set of templates) to perform work duties.

In one aspect, the innovation provides for a system that can automatically convert activity logs into recipes thereby reducing effort in activity reproduction. In another aspect, the system can accept an explicitly established process or procedure from a user in order to define an activity template (e.g., recipe). In yet another aspect, the system can employ self-tuning via machine learning-based algorithms thereby dynamically altering the template in accordance with user action.

In order to create a template, the system can interpret historical activity data from one or more users and extract/generalize the resources and actions relevant to the activity. The system can also allow the logged data to be viewed, modified and/or reused the next time the same (or substantially similar) activity is desired.

Effectively, activity templates can be employed to provide users with a set of actions and resources to accomplish an activity. Accordingly, the system can automatically determine or infer an activity based upon user state thereafter locating a template that can be used to assist in a current activity. Thus, the template can provide a user with the tools and/or resources necessary to replicate and/or automate an activity.

In yet another aspect, an appropriate template can be identified based upon a stated and/or inferred goal. Furthermore, templates can be tailored to a particular user's role in view of a given activity. For example, in accordance with a software development project, a manager can have a different set of responsibilities with respect to those of a developer. As such, different role-specific templates can be generated with respect to an activity. The templates can provide for a parameterization of actions thereby reducing repetitive efforts of a user to gather necessary tools and resources applicable to an activity.

In still other aspects, the templates and/or recipes can be employed to monitor and ensure adherence to protocols. For example, the system can correct and/or redirect a user to conform to a particular set of rules/standards. Additionally, these templates can be employed to facilitate task reacquisition and/or reminder of goals.

An activity template contains the tools and resources needed to perform an activity, including but not limited to, actions (e.g., steps, tasks, views), resources (e.g., data, websites, services, people, schedules, email, etc.), policies (e.g., roles, privacy, etc.), assistance content (e.g., help, tutorials, etc.), user annotations, and template metadata (e.g., to support template searching and selection). Some of these template objects are contained within the template (e.g., policies and metadata) and some are links to external objects (e.g., websites and installed applications).

In summary, this invention enables activity process knowledge to be automatically or manually captured, updated, and improved in a standardized “activity template” format. These templates can then be automatically or manually searched and selected and reused, shared, or transferred (e.g., for free or using various fee models), to, among other things, help users perform similar activities.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates generation of an activity template in accordance with an aspect of the innovation.

FIG. 2 illustrates an exemplary flow chart of procedures that facilitate automatic template generation in accordance with an aspect of the innovation.

FIG. 3 illustrates a system that employs a selection component that determines which steps and/or resources are incorporated into a template in accordance with an aspect of the innovation.

FIG. 4 illustrates an overall activity-centric system in accordance with an aspect of the innovation.

FIG. 5 illustrates a system that employs a refactoring component that extracts elements from an activity log in accordance with an aspect of the innovation.

FIG. 6 illustrates a block diagram of an activity template in accordance with an aspect of the innovation.

FIG. 7 illustrates a system that employs a search and edit component to manage templates within a template storage component in accordance with an aspect of the innovation.

FIG. 8 illustrates a block diagram of a computer operable to execute the disclosed architecture.

FIG. 9 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

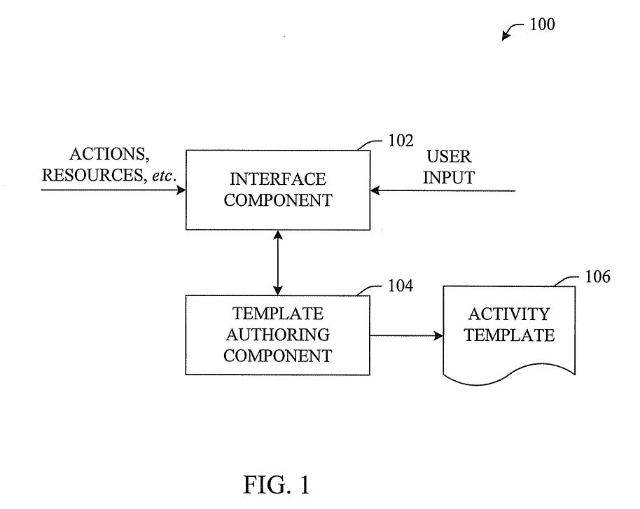

Referring initially to the drawings, FIG. 1 illustrates a system 100 that facilitates capturing process knowledge for user activities. Generally, system 100 includes an interface component 102 and a template authoring component 104 that can enable association, aggregation and collaboration of actions, tasks and resources within an activity-centric environment via an activity template 106.

As shown in FIG. 1, the interface component 102 can accept input automatically from the activity-centric environment. As well, a user can proactively generate an input to the interface component 102. The template authoring component 104 can accept the information from the interface component 102 and thereafter generate and/or update an activity template 106.

Effectively, system 100 enables dynamic or user-prompted generation of an activity-centric template 106 that identifies actions, tasks and resources associated with an activity. As used herein, an “activity” refers to a container for resources which can include data files, application functionality, links to application functionality and steps, tasks or actions. Steps, tasks and/or actions refer to the items that a user would perform to accomplish an activity. Some of the actions can be directly related to a computer, for example, schedule a meeting via a scheduling user interface. On the other hand, some of the actions may not be related to a computer such as, remember to pick up the dry-cleaning or remember to schedule a babysitter.

The actions can have structure to them that enables ordering, ranking, creating dependencies, actions that can be executed in parallel, how many times a step can be executed, which steps are optional versus required, allowable states of a step, rules associated with a one or more steps, etc. As well, the structure of a template 106 can allow the actions to be assigned to various people, devices, and/or services. In one aspect, this structure can be embedded as metadata attached to the individual actions.

Moreover, in addition to structure characteristics, the template authoring component 104 can facilitate defining any number of annotations to the resource items. For example, template properties or metadata can be based upon resource type, user-defined annotations, etc. Some of the predefined template properties for an activity can be the template name that forms the basis for the activity, the proper name, a description, author, version, folders that contain all of the resources associated with an activity, etc.

The policies in a template 106 can be used to identify characteristics such as, if the order is critical, if the order can be changed, etc. In disparate aspects, activities can be nested, grouped and/or sequentially linked. This refers to hierarchical verses non-hierarchical linking. In addition, a template can contain information about the logical desktop of a computer, including but not limited to the desktop wallpaper, open windows/applications, the visual theme of the desktop, the value of system-wide parameters such as “My Documents” and “My Pictures”, etc.

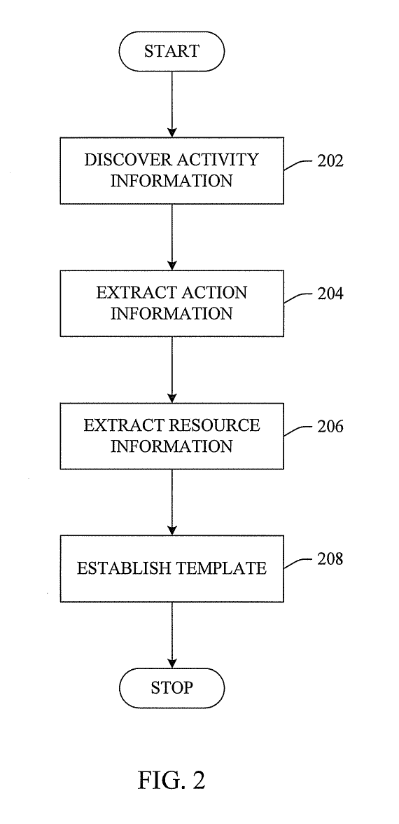

FIG. 2 illustrates a methodology of establishing an activity template in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, activity information such as actions, resources, etc. associated with an activity can be discovered. In one aspect, this activity information can be discovered by monitoring a user and/or group of users. In another aspect, a user can explicitly identify activity information. Accordingly, in an aspect, the information can be logged in an activity log for later retrieval/access. In either case, at 204, action information can be extracted from the activity information. Similarly, resource information can be extracted from the activity information at 206. Once the information is extracted from the discovered information, a template is established at 208.

Although specific template examples and scenarios are described herein, it is to be understood and appreciated that a template can include any information related to an activity. As well, it is to be understood that the information included within a template can also be in the form of a link or hyperlink that accesses information from a remote location. These alternative aspects are to be included within the scope of the innovation and claims appended hereto.

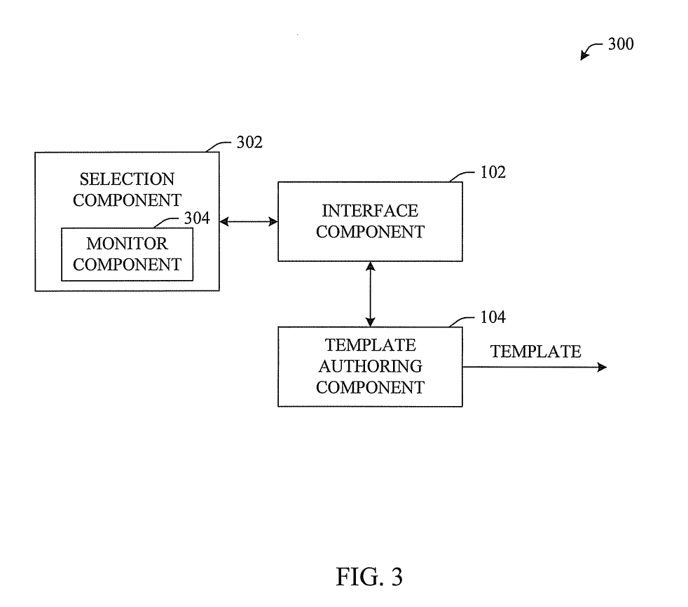

FIG. 3 illustrates an alternative system 300 that facilitates automatic generation and/or update of an activity template in accordance with an aspect of the innovation. Generally, system 300 includes a selection component 302, an interface component 102 and a template authoring component 104. As shown, the selection component 302 can include a monitoring component 304 that monitors actions of a user with respect to an activity selected via the selection component 302.

As well, the monitoring component 304 can dynamically monitor resources associated with an activity. For example, the monitoring component 304 can facilitate monitoring files used, applications launched, websites visited, etc. in correspondence with a selected activity. The interface component 102 can transfer the gathered information to the template authoring component 104 which can establish and/or update the template.

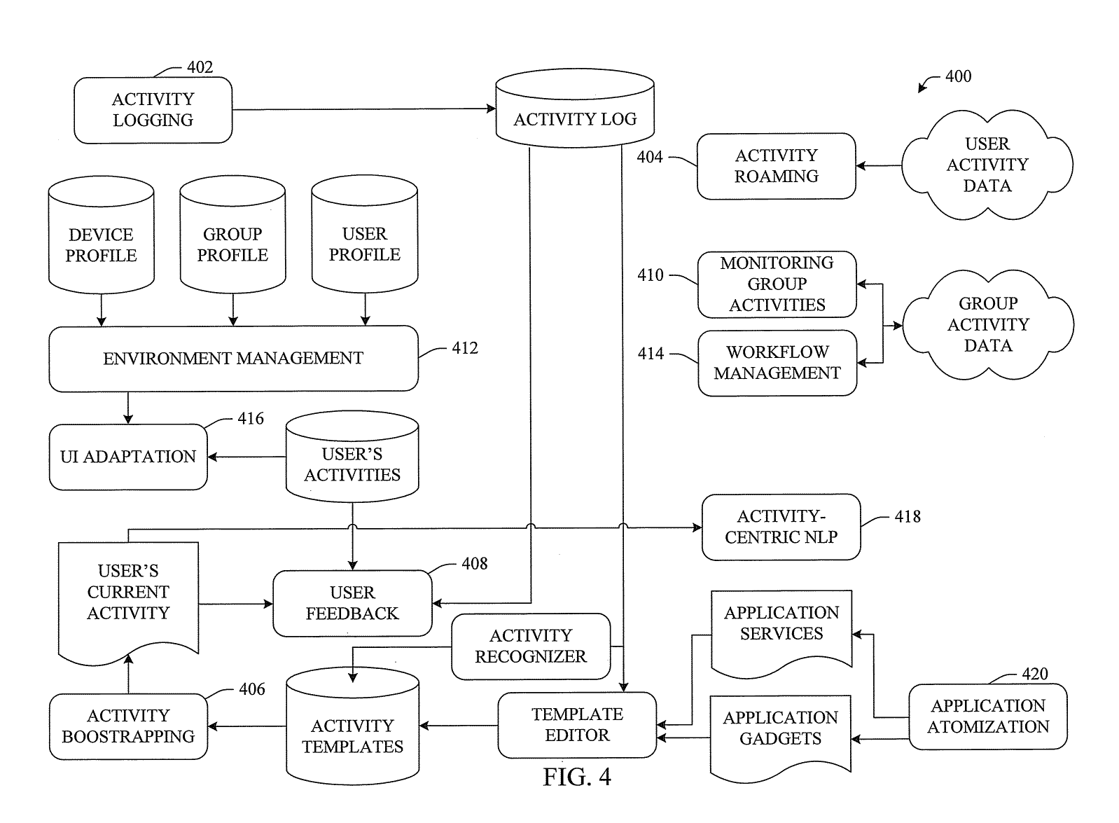

Turning now to FIG. 4, an overall activity-centric system 400 operable to perform novel functionality described herein is shown. As well, it is to be understood that the activity-centric system of FIG. 4 is illustrative of an exemplary system capable of performing the novel functionality of the Related Applications identified supra and incorporated by reference herein. Novel aspects of each of the components of system 400 are described below.

The novel activity-centric system 400 can enable users to define and organize their work, operations and/or actions into units called “activities.” Accordingly, the system 400 offers a user experience centered on those activities, rather than pivoted based upon the applications and files of traditional systems. The activity-centric system 400 can also usually include a logging capability, which logs the user's actions for later use.

In accordance with the innovation, an activity typically includes or links to all the resources needed to perform the activity, including tasks, files, applications, web pages, people, email, and appointments. Some of the benefits of the activity-centric system 400 include easier navigation and management of resources within an activity, easier switching between activities, procedure knowledge capture and reuse, improved management of activities and people, and improved coordination among team members and between teams.

As described herein and illustrated in FIG. 4, the system 400 discloses an extended activity-centric system. However, the particular innovation (e.g., capturing of process knowledge related to user activities) disclosed herein is part of the larger, extended activity-centric system 400. An overview of this extended system 400 follows.

The “activity logging” component 402 can log the user's actions on a device to a local (or remote) data store. By way of example, these actions can include, but are not limited to include, resources opened, files changed, application actions, etc. As well, the activity logging component 402 can also log current activity and other related information. This data can be transferred to a server that holds the user's aggregated log information from all devices used. The logged data can later be used by the activity system in a variety of ways.

The “activity roaming” component 404 is responsible for storing each of the user's activities, including related resources and the “state” of open applications, on a server and making them available to the device(s) that the user is currently using. As well, the resources can be made available for use on devices that the user will use in the future or has used in the past. The activity roaming component 404 can accept activity data updates from devices and synchronize and/or collaborate them with the server data.

The “activity boot-strapping” component 406 can define the schema of an activity. In other words, the activity boot-strapping component 406 can define the types of items it can contain. As well, the component 406 can define how activity templates can be manually designed and authored. Further, the component 406 can support the automatic generation, and tuning of templates and allow users to start new activities using templates. Moreover, the component 406 is also responsible for template subscriptions, where changes to a template are replicated among all activities using that template.

The “user feedback” component 408 can use information from the activity log to provide the user with feedback on his activity progress. The feedback can be based upon comparing the user's current progress to a variety of sources, including previous performances of this or similar activities (using past activity log data) as well as to “standard” performance data published within related activity templates.

The “monitoring group activities” component 410 can use the log data and user profiles from one or more groups of users for a variety of benefits, including, but not limited to, finding experts in specific knowledge areas or activities, finding users that are having problems completing their activities, identifying activity dependencies and associated problems, and enhanced coordination of work among users through increased peer activity awareness.

The “environment management” component 412 can be responsible for knowing where the user is, the devices that are physically close to the user (and their capabilities), and helping the user select the devices used for the current activity. The component 412 is also responsible for knowing which remote devices might be appropriate to use with the current activity (e.g., for processing needs or printing).

The “workflow management” component 414 can be responsible for management and transfer of work items that involve other users or asynchronous services. The assignment/transfer of work items can be ad-hoc, for example, when a user decides to mail a document to another user for review. Alternatively, the assignment/transfer of work items can be structured, for example, where the transfer of work is governed by a set of pre-authored rules. In addition, the workflow manager 414 can maintain an “activity state” for workflow-capable activities. This state can describe the status of each item in the activity, for example, which it is assigned to, where the latest version of the item is, etc.

The “UI adaptation” component 416 can support changing the “shape” of the user's desktop and applications according to the current activity, the available devices, and the user's skills, knowledge, preferences, policies, and various other factors. The contents and appearance of the user's desktop, for example, the applications, resources, windows, and widgets that are shown, can be controlled by associated information within the current activity. Additionally, applications can query the current activity, the current “step” within the activity, and other user and environment factors, to change their shape and expose or hide specific controls, editors, menus, and other interface elements that comprise the application's user experience.

The “activity-centric recognition” component or “activity-centric natural language processing (NLP) component 418 can expose information about the current activity, as well as user profile and environment information in order to supply context in a standardized format that can help improve the recognition performance of various technologies, including speech recognition, natural language recognition, optical character recognition, gesture recognition, desktop search, and web search.

Finally, the “application atomization” component 420 represents tools and runtime to support the designing of new applications that consist of services and widgets. This enables more fine-grained UI adaptation, in terms of template-defined desktops, and well as adapting applications. The services and widgets designed by these tools can include optional rich behaviors, which allow them to be accessed by users on thin clients, but deliver richer experiences for users on devices with additional capabilities.

In accordance with the activity-centric environment 400, once the computer understands the activity, it can adapt to that activity. For example, if the activity is the review of a multi-media presentation, the application can display the information differently as opposed to an activity of the UI employed in creating a multi-media presentation. All in all, the computer can react and tailor functionality and the UI characteristics based upon a current state and/or activity. The system 400 can understand how to bundle up the work based upon a particular activity. Additionally, the system 400 can monitor actions and automatically bundle them up into an appropriate activity or group of activities. The computer will also be able to associate a particular user to a particular activity, thereby further personalizing the user experience.

In summary, the activity-centric concept of the subject system 400 is based upon the notion that users can leverage a computer to complete some real world activity. As described supra, historically, a user would outline and prioritize the steps or actions necessary to complete a particular activity mentally before starting to work on that activity on the computer. In other words, conventional systems do not provide for systems that enable the identification and decomposition of actions necessary to complete an activity.

The novel activity-centric systems enable automating knowledge capture and leveraging the knowledge with respect to previously completed activities. In other words, in one aspect, once an activity is completed, the subject innovation can infer and remember what steps were necessary when completing the activity. Thus, when a similar or related activity is commenced, the activity-centric system can leverage this knowledge by automating some or all of the steps necessary to complete the activity. Similarly, the system could identify the individuals related to an activity, steps necessary to complete an activity, documents necessary to complete, etc. Thus, a context can be established that can help to complete the activity next time it is necessary to complete. As well, the knowledge of the activity that has been captured can be shared with other users that require that knowledge to complete the same or a similar activity.

Historically, the computer has used the desktop metaphor, where there was effectively only one desktop. Moreover, conventional systems stored documents in a filing cabinet where, there was only one filing cabinet. As the complexity of activities rises, and as the similarity of the activities diverges, it can be useful to have many desktops available that can utilize identification of these similarities in order to streamline activities. Each individual desktop can be designed to achieve a particular activity. It is a novel feature of the innovation to build this activity-centric infrastructure into the operating system such that every activity developer and user can benefit from the overall infrastructure.

The activity-centric system proposed herein is made up of a number of components as illustrated in FIG. 4. It is the combination and interaction of these components that compromises an activity-centric computing environment and facilitates the specific novel functionality described herein. At the lowest level the following components make up the core infrastructure that is needed to support the activity-centric computing environment; Logging application/user actions within the context of activities, User profiles and activity-centric environments, Activity-centric adaptive user interfaces, Resource availability for user activities across multiple devices and Granular applications/web-services functionality factoring around user activities. Leveraging these core capabilities with a number of higher-level functions are possible, including; providing user information to introspection, creating and managing workflow around user activities, capturing ad-hoc and authored process and technique knowledge for user activities, improving natural language and speech processing by activity scoping, and monitoring group activity.

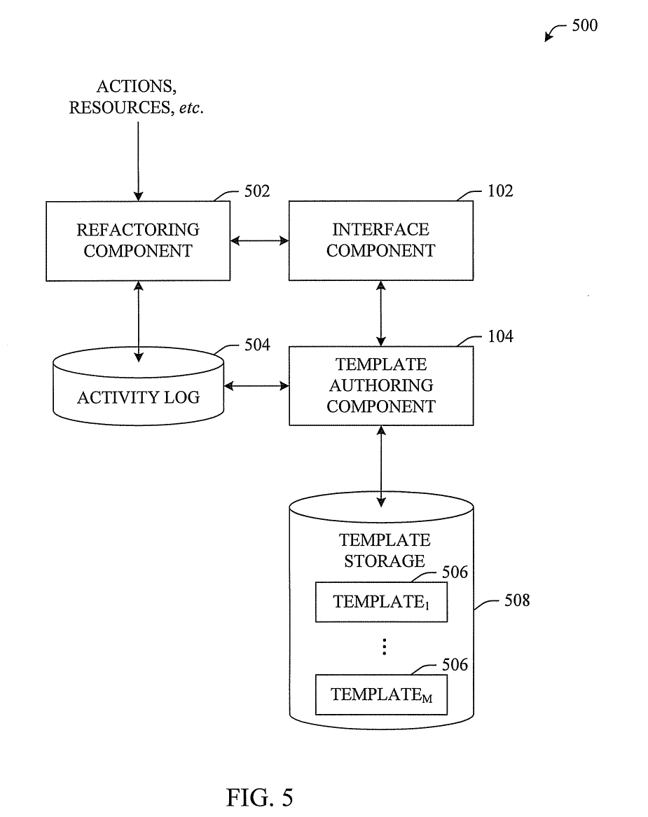

Referring now to FIG. 5, an alternative aspect of the innovation that facilitates template generation is shown. Effectively, generation of a template can be performed in a variety of manners, including, ad hoc (e.g., machine generated for a current activity), automatically (e.g., machine generated for a future activity) and explicitly (e.g., user-authored with optional machine assistance for future activity). FIG. 5 illustrates a system 500 that facilitates establishing a template(s) in accordance with the first category, an ad hoc template. As described with respect to FIG. 3 above, ad hoc templates can be automatically created by monitoring a user action associated to a current activity, thereafter creating the template. For example, in accordance with planning a trip, the system can record websites visited, files created, people interacted with, other steps and actions taken or performed with respect to planning a trip. Thus, a user can dictate creating a new activity from scratch or making a new activity based upon an older activity worked on in the past.

In accordance with monitoring user action and activity resources, system 500 employs a refactoring component 502 in conjunction with a log 504. “Refactoring” refers to a process of distinguishing between what should be included within the template and what is just uninteresting action logged by the system. In operation, the refactoring component 502 can receive actions and resources thereafter making a determination of whether the information is useful and should be logged (e.g., into activity log 504).

Further, the refactoring component 502 can make a decision if the monitored information should be provided to the template authoring component 104 (via interface component) in order to establish a template 506 in the template storage 508. As shown, a template storage component 508 can be provided that includes 1 to M templates, where M is an integer. It is to be understood that 1 to M templates can be referred to individually or collectively as template 506.

The items to be included within a template 506 can be categorized into 2 classes: steps or resources that are included into a template 506 “as is” and those steps or resources that need to be “parameterized.” In other words, steps or resources that have to be “parameterized” refer to those in which their value within the template 506 is not complete. In other words, a “parameterized” step or resource refers to those in which the value depends on some user input, other template data, or some external data, for example, user data/context, environmental data/context, device data/profile, group data/context, etc. This value is used when the template 506 is converted into an activity.

To the extent that the system 500 can perform automatic analysis of the log 504 to determine or predict the interesting actions as well as the uninteresting actions, this is particularly helpful to establishing useful templates 506. This refactoring process (e.g., refactoring component 502) can also leverage the human viewable portion of the log 504 thus enabling a user to identify useful information. Also, both system and user input can be used in determining which items are “parameterized” and, if so, to what they depend upon.

Moreover, the template authoring component 104 can extract items from the log 504 thereafter inferring and building a template. Thus, in ad hoc template creation scenario, the template authoring component 104 can take an activity a user is working on, combine information from a log and ultimately convert the information into a template.

In a second category, the user can employ the template authoring component 104 to explicitly define the characteristics of a template 506. In one example and in accordance with these highly structured or authored templates 506, a user could explicitly create a template 506 if they intend to share it with someone. As well, a user can explicitly establish a template 506 if it is desired to make sure that the activity is performed the same way each time. For instance, in order to comply with predefined regulations, a template 506 can be established that considers the criteria of the subject regulation.

It is to be understood that there are at least two distinctions between a definition of an activity and the resources associated with the activity. In accordance with a first scenario, a user can complete a set of work and decide to carry it forward by basically making a copy of the steps used to complete the work. Some of the sequence of steps or set of parameters in the set of work can be specific to an instance of the activity and therefore could be stripped out (e.g., extracted) in order to create a template. This filtering is particularly important because a template 506 can be viewed as an activity before it has been instantiated. In order to provide perspective, in programming terms, an activity template 506 can be viewed as a class where an activity instance is an object.

An activity would have the steps (or actions) that a template 506 has in it, however the activity might be more specific to an instance. This concept can be thought of as a word processing document template and a word processing document. The document is generated from the template 506 and includes everything in the template 506, and more.

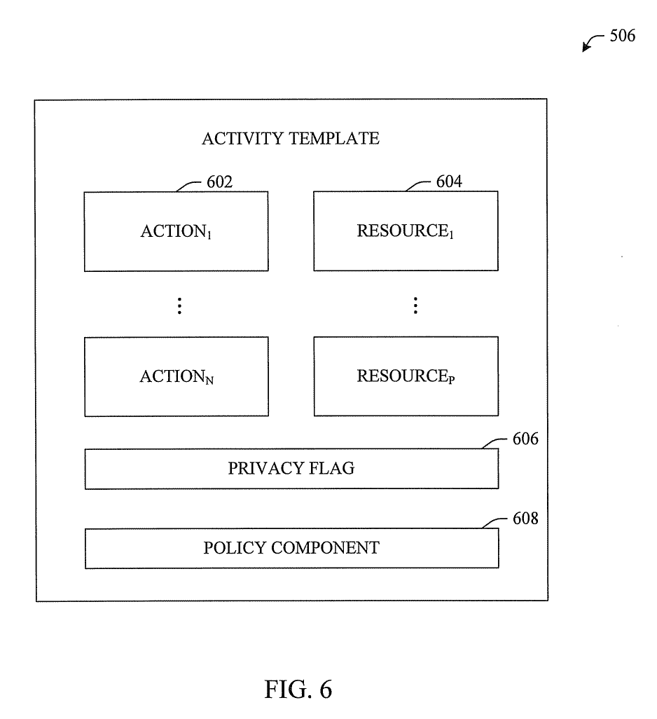

FIG. 6 illustrates a template 506 in accordance with an aspect of the innovation. As shown, the template 506 can include 1 to N action (or step) components 602, where N is an integer. As well, 1 to P resource components 604 can included, where P is an integer. Moreover, the template 506 can include a privacy flag 606 and a policy component 608. In operation, the privacy flag 606 can be used to identify if a policy is to be applied. If so, the policy component 608 can be employed to establish the details of any such policy. For example, a user may want portions of an activity to be private to the user, portions private to a company, and portions public. Similarly, a company may want conflicting privacy settings. It is to be understood that effectively any privacy setting can be represented within the template.

It is to be understood that the activity template 506 illustrated in FIG. 6 is an example of a template that can be authored in accordance with the functionality of the innovation. To this end, it should be understood and appreciated that other templates can exist that have additional and/or fewer components than those illustrated in FIG. 6. For example, a template can include most any combination of actions (e.g., tasks, steps, views), resources (e.g., data, services, websites), policies (including privacy), assistance (e.g., help, tutorial), user annotations, metadata (e.g., publisher, priority), etc. As such, these alternative templates are to be considered a part of the innovation and claims appended hereto.

The template 506 can specify how an application or widget should appear on the screen (e.g., view). For example, the location, size, visual style, functionality present, visual priorities, preferred controls, etc. can be identified within the template 106. The template 506 can also include performance data, for example, how long an activity or step within an activity is expected to take. Additionally, a template 506 can contain “user assistance” or “help” media (e.g., rich text, animations, interactive tutorials). Also, any step or the activity as a whole may contain “guided help” which can refer to an automated system that shows a user how to execute a step (or series of steps), or teaches the user how to do the step, as the system performs it.

Basically, a template 506 can be viewed as a clean start of an activity. An activity instance can be seen as an activity “in progress” with some of the steps/actions checked off which are specific to that activity and that point in time. The instance can also have a log and state associated with it.

As shown in FIG. 5, the activity log 504 can be employed to infer a template 506, for example, a step or action such as “book the caterer” which is accomplished via a web service, can be instantiated within the context of the activity and can be used to establish a template. In all, monitored and/or logged information can be rendered to a user whereby a user can decide whether or not to include the step into the template. In other words, a user can explicitly select actions from a visual display (e.g., graphical user interface) of the log thus establishing a template.

In still another aspect, the act of inferring templates from activities can be accomplished by analyzing multiple activities from the same or multiple users. More particularly, the system can compare commonalities and structure between the activities thereafter inferring the template(s) 506. In accordance with an aspect, templates can be created in a variety of manners, for example, user-handcrafted templates, system inferred templates, and templates inferred from multiple activities or multiple people. It is to be understood that each of these techniques need not be exclusive. For example, an inferred template may be refined by user handcrafted changes. As well, for any component of the template (e.g., action, resource, policy, etc), the component could be machine-authored (with optional user approval), user-authored, or user-authored with machine assistance.

The subject innovation also discloses mechanisms that enable sharing and transferring templates. Suppose a user develops a template for accomplishing something and later identifies that another template exists for the same or similar activity, here, the innovation can provide for sharing and/or comparing templates. In addition to template creation or authoring, the innovation also addresses template editing and searching.

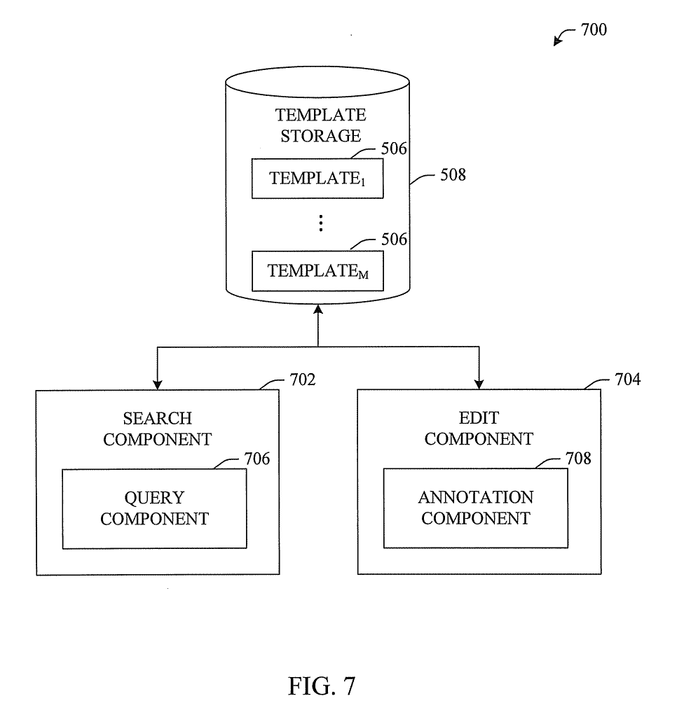

FIG. 7 illustrates a system 700 that enables searching and editing templates 506 within the template storage component 508. More particularly, the system 700 can include a search component 702 that enables identification of particular templates within a template storage component 508. For example, suppose a user is engaging in an activity and would like to search for templates of similar activities, the search component 702 can facilitate identification of other templates 506 that correspond to the same and/or similar activities.

More specifically, as shown in FIG. 7, a query component 706 can be used to identify a desired template and/or to describe a particular activity or group of activities. This query can be user identified and/or automatically generated by analyzing monitored user activity. For example, if the system identifies that a user is accessing a website with respect to used car prices, blue book values, pre-owned vehicles for sale, etc., a query can be established that searches the template storage component 508 for templates 506 related to the same or similar activities of “purchasing a pre-owned car.” In this example, a template 506 can be identified that is directed to “purchasing a new car” which can be used as a basis for the subject activity. More particularly, as will be understood, many of the steps and resources used in “purchasing a pre-owned car” will be the same as those in connection with “purchasing a new car.” Thus, the user can leverage existing templates in a current activity.

The template storage component 508 can represent multiple physical storage devices (e.g., local to the user's device, on file servers, on websites, exposed thru web services, etc.). The user can control the scope of the locations searched as part of the query.

As well, the edit component 704 can enable a user to edit an existing template 506. For instance, if a user determines that a template 506 is not accurate or could be improved, the user can edit the template to correct and/or further refine in scope. Similarly, continuing with the aforementioned example, suppose a user searches and locates a template for “purchasing a new car,” here, the user can employ the edit component 704 to create another template (e.g., “purchasing a pre-owned car” utilizing the basic format of the first template. As well, if preferred, the user can create one common template 506 related to “purchasing a car” while using the annotation component 708 to annotate steps and/or resources within the template thereby identifying which steps and/or resources should be applied in a given situation (e.g., new versus pre-owned).

In this example, it will be appreciated that steps and/or resources can differ in each of these activities. For instance, in a new car scenario, it might be helpful to know the dealer invoice price of a car. This information may not be particularly helpful in the pre-owned car scenario. Similarly, in the pre-owned car scenario, a user might be interested in knowing the maintenance history of the vehicle, which is not helpful in a new car scenario. In either instance, steps and resources to identify this information can be identified within the template 506.

Effectively, in accordance with an aspect of the innovation, an application developer can create a rich template 506 which refers to a container for the functionality they ship. For example, an accounting application can be built to include a personal finance activity container that includes specific functionality contained therein. In accordance with the innovation, in the future, the developer can create tools such as finance, budgeting, saving analysis, etc. These tools can be stored within a template 506 or set of templates that eventually become the user experience around the tools. It is to be understood that these templates can include functionality beyond the functionality originally shipped.

Further, a third party that does not own any application functionality can also establish templates 506 to aggregate activity functionality. Moreover, an author of an activity template 506 can lock the template thus not allowing another to view and/or modify the template.

As described above, a template 506 can require a user to store documents in a particular area. Also as described above, the system can allow a user to annotate and/or amend the template 506 without changing the outcome of the template (e.g., outcomes, sequence of work, assignment of work, etc.). In other words, there can be areas defined for which the user can freely modify and/or change to personalize the experience. With respect to a template 506, a policy (e.g., 608 of FIG. 6) can be applied that can determine which aspects of the template 506, if any, can be changed, and by who. The policy can be dictated by a user, a first party developer or a third-party.

As the system is monitoring, the user can flag the log to identify relevant activities. These flags (e.g., 606 of FIG. 6) can be used by the system to establish templates 506. In summary, the innovation described herein discloses a template authoring tool (e.g., 104 of FIG. 1), a personal (or public) repository (e.g., 508 of FIG. 5) for storing templates (e.g., 506 of FIG. 5). In accordance therewith, the innovation discloses mechanisms for merging, comparing, sharing, searching, editing, annotating and transferring templates 506.

As well, in some circumstances, the innovation facilitates updating in-use activities when the respective templates 506 are changed. In aspects, even though the relationship between a template 506 and an activity is severed when an activity is created, the innovation can provide for the ability to propagate changes. For example, if a particular database is moved such that all the links within the template 506 will be rendered inoperable, in these cases, the changes can be automatically propagated from the template 506 to the in-use (and other related) activities that were created from the template 506.

Another policy consideration is that a personal template might include private information. In operation, when the template 506 is shared, the shared version can be stripped of the information designated as “private.”

With respect again to annotating, there can be standardized ways of annotating templates (e.g., via annotation component 704) which facilitate standard methods of searching. For example, a search query (e.g., 706) can be expressed as “show all templates that use components from at least these three vendors.” This can be used if the user is shopping for a vacation and might want to use three specific travel agencies. Similarly, a search query 706 can be established that identifies all of the templates 506 that use specific applications.

It will be appreciated that the activity template 506 can include other templates for other lower level (nested) activities. These templates 506 can be related either to each other or hierarchical. Furthermore, the template 506 as well as actions within the template 506 can contain assistance content which can enable rich information to a user such as, why is this important?, how do you do it?, etc. This is effectively a dynamic template 506 that enables a cumulative way to get descriptive information there. It contains much richer information about the context.

In other aspects, a feedback mechanism (not shown) can be provided where users can supply information as to how the activity is being used or how useful or accurate the documentation or resource is with respect to the activity. In addition, the feedback data can include activities or steps that the user wanted to do but were not available to allow template, view, service, and applications developers to consider authoring them in the future. As well, the feedback data can provide another search pivot with respect to the templates.

In another aspect, an artificial intelligence (AI) or machine learning and reasoning (MLR) component can be employed which facilitates automating one or more features in accordance with the subject innovation. The subject innovation (e.g., in connection with step/action and resource identification and/or extraction) can employ various AI-based schemes for carrying out various aspects thereof. For example, a process for determining when to include a step or resource into a template can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic, statistical and/or decision theoretic-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. By defining and applying a kernel function to the input data, the SVM can learn a non-linear hypersurface. Other directed and undirected model classification approaches include, e.g., decision trees, neural networks, fuzzy logic models, naïve Bayes, Bayesian networks and other probabilistic classification models providing different patterns of independence can be employed.

As will be readily appreciated from the subject specification, the innovation can employ classifiers that are explicitly trained (e.g., via a generic training data) as well as implicitly trained (e.g., via observing user behavior, receiving extrinsic information). For example, the parameters on an SVM are estimated via a learning or training phase. Thus, the classifier(s) can be used to automatically learn and perform a number of functions, including but not limited to determining, according to a predetermined criteria, when to incorporate information into a template, if/how/when to refactor activity information, etc.

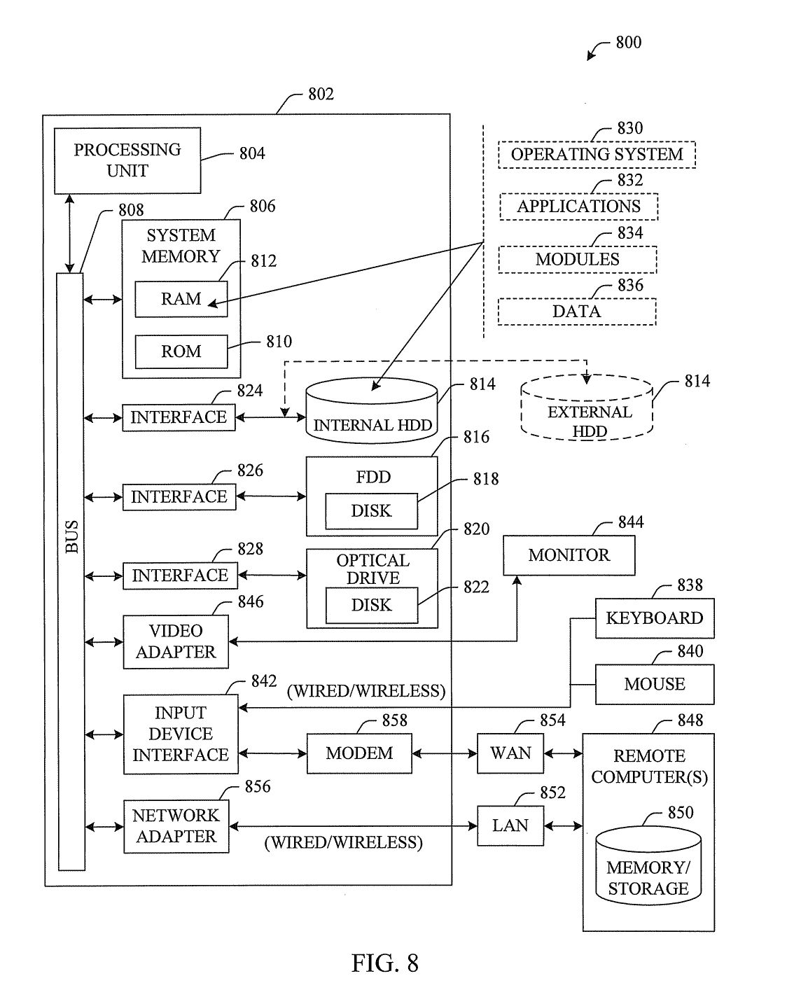

Referring now to FIG. 8, there is illustrated a block diagram of a computer operable to execute the disclosed architecture. In order to provide additional context for various aspects of the subject innovation, FIG. 8 and the following discussion are intended to provide a brief, general description of a suitable computing environment 800 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the innovation includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the innovation can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

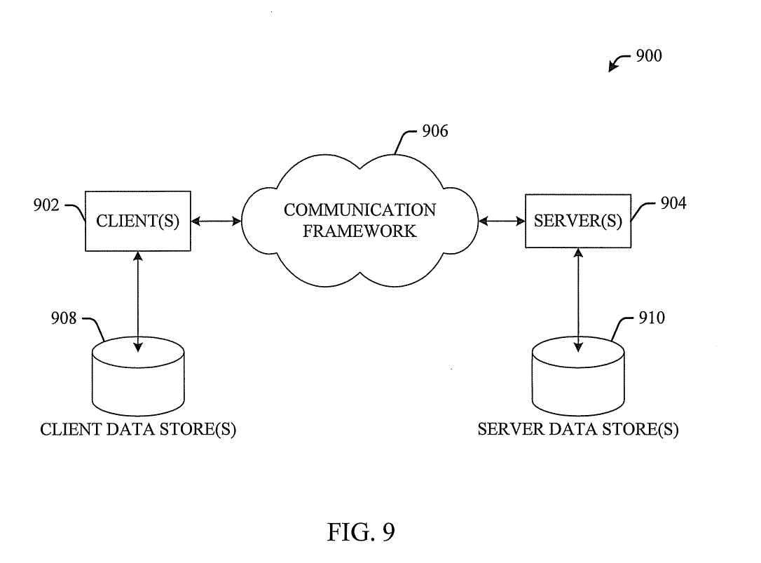

Referring now to FIG. 9, there is illustrated a schematic block diagram of an exemplary computing environment 900 in accordance with the subject innovation. The system 900 includes one or more client(s) 902. The client(s) 902 can be hardware and/or software (e.g., threads, processes, computing devices). The client(s) 902 can house cookie(s) and/or associated contextual information by employing the innovation, for example.

The system 900 also includes one or more server(s) 904. The server(s) 904 can also be hardware and/or software (e.g., threads, processes, computing devices). The servers 904 can house threads to perform transformations by employing the innovation, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates activity template generation, comprising:
an interface component that accesses a plurality of elements of an activity; and
a template authoring component that facilitates creation of an activity template based at least in part upon a subset of the plurality of elements.

2. The system of claim 1, the template authoring component enables automatic creation of the activity template as a function of monitoring the plurality of elements.

3. The system of claim 1, the template authoring component enables handcrafted creation of the activity template based at least in part upon a user preference.

4. The system of claim 1, the plurality of elements includes at least one of a plurality of action identifiers and a plurality of resource identifiers.

5. The system of claim 1, the activity template further comprises privacy data that enables a user to limit access to information within the subset of the plurality of elements.

6. The system of claim 1, the activity template further comprises a policy component that enables management of edit characteristics with respect to the activity template.

7. The system of claim 1, further comprising:
a monitoring component that monitors user activity; and
a selection component that automatically selects the subset of the plurality of elements based at least in part upon the monitored user activity.

8. The system of claim 1, further comprising a refactoring component that selects the plurality of elements from an activity log as a function of the activity.

9. The system of claim 1, the template authoring component facilitates storage of the activity template in a template storage component.

10. The system of claim 9, further comprising a search component that enables search of the template storage component to identify a desired template.

11. The system of claim 10, further comprising an edit component that facilitates editing a desired template obtained from the template storage component.

12. A computer-implemented method of establishing a template, comprising:
accessing a plurality of elements associated with an activity; and
determining a subset of the plurality of elements that are to be included within a template associated with the activity; and
generating the template associated with the activity.

13. The computer-implemented method of claim 12, further comprising monitoring a user as a function of the activity to automatically establish the plurality of elements.

14. The computer-implemented method of claim 12, further comprising manually identifying the plurality of elements associated with the activity.

15. The computer-implemented method of claim 12, further comprising maintaining the template in a template storage component together with a plurality of other activity templates.

16. The computer-implemented component of claim 15, further comprising:
searching the template storage component; and
identifying a template that corresponds to an activity similar to the activity.

17. The computer-implemented component of claim 16, further comprising editing the templates that corresponds to the similar activity.

18. A system that facilitates generation of an activity template, comprising:
means for monitoring a user to identify a plurality of actions and a plurality of resources;
means for extracting a subset of the plurality of actions as a function of an activity;
means for extracting a subset of the plurality of resources as a function of the activity; and
means for generating the activity template that comprises the subset of the plurality of actions and the subset of the plurality of resources.

19. The system of claim 18, the activity template further comprises at least one of a policy, a privacy policy, an assistance portion, a user annotation and metadata.

20. The system of claim 19, further comprising:
means for searching the plurality of activity templates to identify a similar template; and
means for modifying the similar template to establish the activity template.
